(19) United States
(12) Patent Application Publication
(10) Pub. No.: US 2008/0274439 A1
(43) Pub. Date: Nov. 6, 2008

(54) Dental device for use in the obturation of a root canal

(76) Inventors: Andreas E. Gutzner, Reichenau (DE); Joachim E. Klee, Radolfzell (DE)

Correspondence Address: DENTSPLY INTERNATIONAL INC, 570 WEST COLLEGE AVENUE, YORK, PA, 17404, US

(21) Appl. No.: 11/890,411

(22) Filed: Aug. 6, 2007

(30) Foreign Application Priority Data
Jan. 3, 2006 (EP) PCT/EP06/00963

(51) Int. Cl. A61C 5/02; B65D 83/00

(52) U.S. Cl. 433/102; 206/368

(57) ABSTRACT

Kit-of-parts containing
(i) a dental device for use in the obturation of a root canal which comprises a tapered obturating point portion integrally connected at the distal end of a functional portion, whereby the functional portion comprises
   (a) a neck portion adjacent to the obturating point portion, and
   (b) a handle portion, and
(ii) a dental sealant composition,
   wherein the dental device is made of a material obtainable by curing a composition containing one or more curable components contained in the dental sealant.

### FIELD OF THE INVENTION

The present invention relates to a kit-of-parts containing a dental device for use in the obturation of a root canal, and a sealant. The kit-of-parts according to the invention may be used to provide a monoblock obturation of a root canal. The present invention also relates to a dental device for use in the obturation of a root canal, which may be used in a kit-of-parts of the present invention. The present invention further relates to a process for the preparation of a dental device according to the invention.

### BACKGROUND OF THE INVENTION

The total obturation of the root canal system is the primary goal of endodontic therapy. The lack of complete obturation appears to be the most frequent cause of failure of endodontic therapy for the following reason.

The root canal system is complex. Teeth may contain many canals. Incisors may contain two major canals. Premolars may contain three major canals. Molars, especially lower molars, may contain five major canals. Moreover, any major root canal may include loops, fins, lateral and accessory canals. During endodontic therapy, the three-dimensional root canal system must be cleaned and filled with a solid homogenous filling. If these canals are not cleaned and filled, a perpetuation of a lesion is inevitable. Lesions will eventually lead to inflammation and even loss of the tooth.

Dental root canal obturating points for use in endodontic therapy are known. Conventional obturating points are prefabricated polymeric based or metallic cones comprising a broad end and a narrow end (tip). The points are introduced into a root canal during root canal therapy for filling the cleaned and shaped major root canal in a manner to completely obturate the root canal.

In the last decades, gutta-percha cones in combination with a root canal sealer are the most popular material used for root canal filling by lateral condensation or master-point technique. Accordingly, a root canal sealer is applied and a plurality of gutta percha points are inserted to fill the major canal. A first obturating point is placed to seal the apical opening and a number of accessory points are used to fill the remainder of the canal. A sharp steel instrument is used to compress the points and spread the gutta percha in a lateral direction to fill the major and accessory canals. The instrument creates large lateral forces which can fracture the tooth in the absence of extreme care. Moreover, the lowermost point can be forced through the apical opening and into the surrounding tissue, causing inflammation. In addition, the gutta percha frequently adheres to the compression instrument and, unless the instrument is withdrawn cautiously, the filling will be loosened or displaced as the instrument is removed.

To improve the clinical success further and to make the root canal therapy more easily and safe an excellent connection between root canal sealer and cavity wall on the one side and root canal sealer and root canal obturating points must be achieved by a new application technique. Moreover, the preparation process of an obturating point must be easily accomplished at a low cost whereby the obturating points are obtained at a high quality.

U.S. Pat. No. 5,051,093 discloses a root canal filling device including a single use obturator and a multiple use elongate inserter tool.

US2003/0045604 discloses a soluble and thermoplastic dental root canal cone that is easy to remove, that undergoes a connection to the thermoplastic sealer and which provides a radio-opacity of at least 3 mm/mm Al. The dental root canal filling cones of US2003/0045604 comprise filler and thermoplastic polymer, wherein the thermoplastic polymer is formed by polymerization of polymerizable diepoxide monomer and amine monomer, said amine monomers being primary monoamine and/or a disecondary diamine, said filler comprising 40 to 90 weight-% of said cones providing a radio-opacity of at least 3 mm/mm aluminum. Furthermore, US2003/0045604 discloses a process for the preparation of dental root canal filling cones comprising the steps of thermal addition polymerization of a diepoxide monomer and an amine monomer on the filler surface; and forming (casting) process of the surface-modified filler of by thermal and/or pressure processes. US2003/0045604 does not teach or suggest a dental device for use in the obturation of a root canal.

WO2004/115589 discloses an endodontic obturator comprising a shaft section and a filler section fabricated of the same material and formed as a single unit. A handle section may be included and may be formed integrally with the shaft section and filler section as a single unit. WO2004/115589 does not disclose a kit-of parts comprising an endodontic obturator and a specific sealant.

It is a problem of the present invention to provide kit-of-parts containing a dental device and a root canal sealant which may be used to provide a monoblock obturation of the root canal.

It is a problem of the present invention to provide kit-of-parts containing a dental device and a root canal sealant having chemical compatibility with the dental device when used in the obturation of a root canal.

It is a further problem of the present invention to provide a dental device for use in the obturation of a root canal, which may be used to easily apply and remove an obturating point during endodontic therapy, whereby the device may be easily manufactured.

Finally, it is a problem of the present invention to provide a process for the preparation of a dental device according to the invention.

### SUMMARY OF THE INVENTION

In a first aspect, the present invention provides a kit-of-parts containing
(i) a dental device for use in the obturation of a root canal which comprises a tapered obturating point portion integrally connected at the distal end of a functional portion, whereby the functional portion comprises
   (a) a neck portion adjacent to the obturating point portion, and
   (b) a handle portion, and
(ii) a dental sealant composition,
   wherein the dental device is made of a material obtainable by curing a composition containing one or more curable components contained in the dental sealant.

The invention provides a kit-of-parts which may be used to form a monoblock obturation in a root canal which adheres to the wall of the root canal. The monoblock obturation represents an essentially homogeneous material. Accordingly, the dental device is made of a material obtainable by curing a composition containing one or more curable components contained in the dental sealant.

The invention also suggests a new shape and preferable surface of a dental device for use in the obturation of a root canal so as to facilitate handling properties and enhance the precision of the root canal obturation.

The handle portion of a dental device for use in the obturation of a root canal according to the invention may be firmly gripped by the finger of the operator or indirectly with an instrument like tweezers. By applying pressure, the tapered obturating point portion is pushed into its final position. The handle portion is preferably flat and can be easily bypassed by an instrument used to cut back the point at the end of the procedure. A flat surface preferably provided at the handle portion also offers space for imprints to identify size and taper of the point.

The neck portion of a dental device for use in the obturation of a root canal according to the invention connects the handle portion with the intra-canicular tapered obturating point portion. The neck portion may have a reduced diameter in comparison to the tapered obturating point portion which facilitates the cut back of the point at the end of the procedure. In the neck portion a silicon stop may be mounted which helps to control that the tapered obturating point portion reaches its final position that is identical to the length of the root canal preparation instrument used. The neck portion may have essentially the same diameter along its length so as to allow the use of a stopper to be slidably displaced and positioned at the neck portion.

The intra-canicular tapered obturating point portion of a dental device for use in the obturation of a root canal according to the invention is preferably shaped like the corresponding root canal instruments. It may exhibit an axial groove which allows excess sealant to escape in a coronal direction. The surface of the intra-canicular tapered obturating point portion preferably has a micro structure which allows an easy and complete wetting of the surface of the point with the root canal sealant and which also improves the bond strength between the root canal point and the root canal sealant.

In a second aspect, the present invention provides a dental device for use in the obturation of a root canal, which comprises a tapered obturating point portion integrally connected at the distal end of a functional portion, whereby the functional portion comprises
(a) a neck portion adjacent to the obturating point portion, and
(b) a handle portion.

In a third aspect, the present invention provides a process for the preparation of a dental device according to the invention, which is characterized by the steps of
(a) providing a thermoplastic polymeric material; and
(b) forming the dental device.

In a fourth aspect, the present invention provides a use of the dental device of the invention for filling a dental root canal.

### BRIEF DESCRIPTION OF THE FIGURES

FIG. 1a shows a dental device according to the invention further comprising a stopper means mounted at the neck portion.

FIG. 1b is a schematic representation of the crossection of a flat handle portion of a preferred dental device according to the invention.

FIG. 1c shows a dental device according to the invention.

FIG. 1d shows an enlarged view of a shoulder portion integrally connecting the tapered obturating point portion at the distal end of a functional portion.

FIG. 2 a-e is an illustration of steps involved in a root canal therapy using the dental device according to the invention.

FIG. 3 shows a system of dental devices having different obturating point portions and corresponding indications at the handle portion.

FIG. 4 shows a further system of dental devices having different obturating point portions each including an elongated channel portion for draining excess sealant.

FIG. 5 shows an embodiment of a system of dental devices as shown in FIG. 4 arranged in a suitable dental chair side tray.

### DESCRIPTION OF THE PREFERRED EMBODIMENTS

The kit-of-parts according to the present invention contains a dental device and a dental sealant composition. The dental device is made of a material obtainable by curing a composition containing one or more curable components contained in the dental sealant. Accordingly, the material of the dental device is compatible with the cured sealant. Preferably, the dental device is obtainable by curing a composition containing the curable components of the correspondent sealant composition.

The dental sealant may be an epoxide-amine based root canal sealant such as AH Plus (Dentsply De Trey) having an adhesion of 4 MPa (J D Pecora et al., Braz. Dent. J. 12 (2001) 27) that shows when bonded to the cavity walls of a root canal. In case the sealant is an epoxide-amine based root canal sealant, the material of the dental device is a cured epoxide amine polymer.

Preferably, the adhesion of the sealant to the material of the dental device is higher than the adhesion of the sealant to gutta percha in a shear bond strength test (Gogos C.; et al Journal of Endodontics, Vol 30, No. 4 (2004) p. 238-240) by using two test specimens of the dental device having a circular bonding surface (diameter: 3 mm) which are bonded by using the sealer and which are subsequently subjected to the shear bond test using a Zwick Z010 TND device under the conditions as disclosed by Gogos et al. Moreover, in a specific embodiment of the kit-of-parts of the invention, the adhesion of the sealant to the root canal wall is higher than the adhesion of the sealant to the material of the dental device in a shear bond strength test (Gogos C. et al). Accordingly, any failure of the bond between the dental device and the wall of the root canal will occur between the sealant layer and the dental device thereby providing continued protection of the wall of the root canal. In a further specific embodiment, of the kit-of-parts of the invention, the adhesion of the sealant to the root canal wall is at most as high as the adhesion of the sealant to the material of the dental device.

The dental device may be made of a material obtainable by a chain growth polymerization reaction or by a step-growth polymerization reaction. In a preferred embodiment, the dental device is made of a material containing an epoxide amine polymer.

Preferably the kit contains a system of dental devices. The system may contain two or more different embodiments of the dental device according to the invention. The system may contain one or more dental devices of each embodiment. Preferably, the system comprises embodiments having obturating points with different tapers or diameters in order to be useful for obturating root canals of different sizes and shapes. Preferably, the system of dental devices is presented in a tray wherein the dental devices are arranged and releasably attached so that identification and handling during a dental procedure is facilitated.

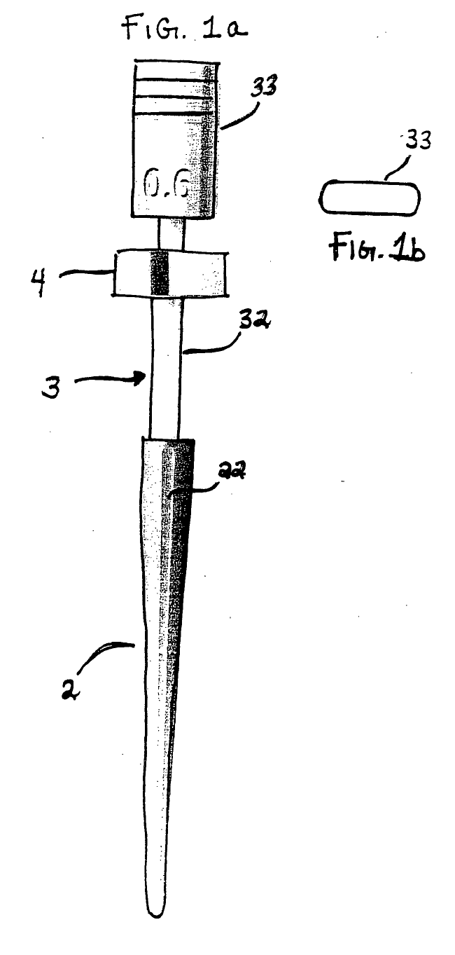

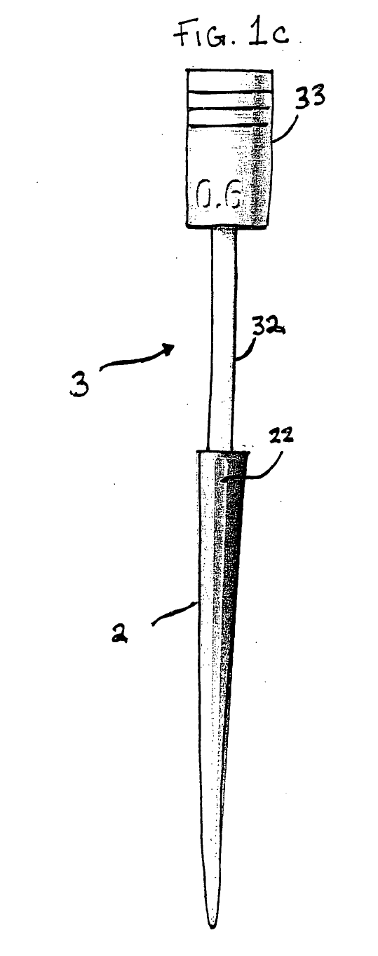

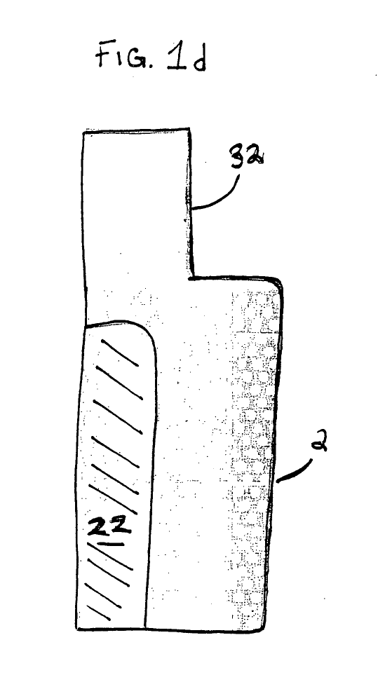

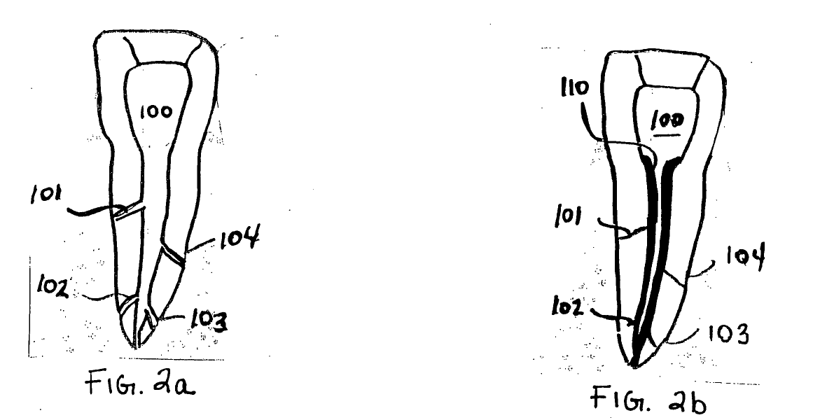

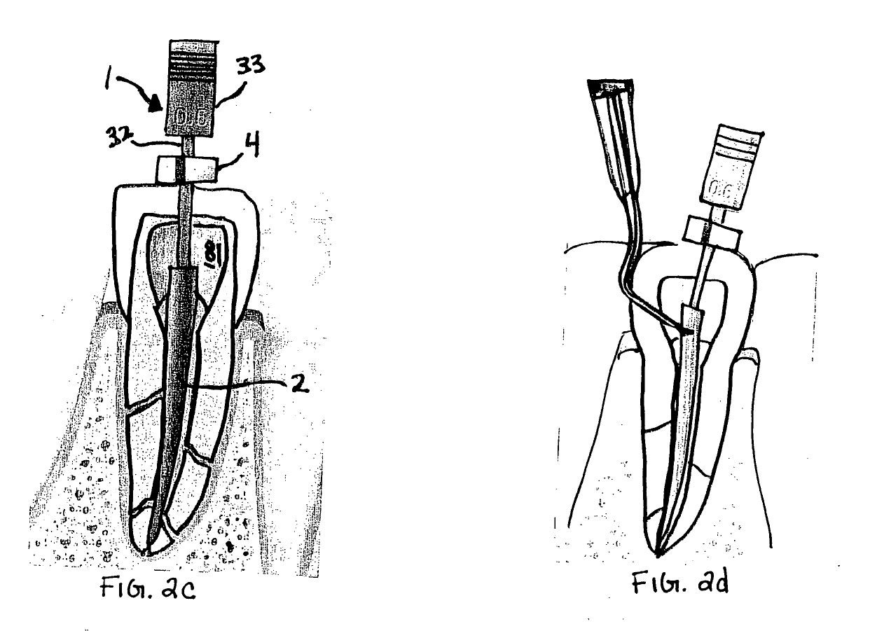

As shown in FIG. 1a, the dental device comprises a tapered obturating point portion 2 integrally connected at the distal end of a functional portion 3, whereby the functional portion 3 comprises a neck portion 32 adjacent to the obturating point portion 2, and a handle portion 33. The handle portion 33 has a flat shape thereby providing a surface for an imprint. Moreover, the flat shape of the handle portion reduces any undesired visual obstruction. The neck portion 32 is provided with a stopper means 4 such as a silicon stopper. The stopper means may be color coded so as to indicate the type or size of the tapered obturating point portion 2. The neck portion 32 has a reduced diameter as compared to the tapered obturating point portion 2, thereby reducing any undesired visual obstruction. Moreover, the reduced diameter of the neck portion 32 improves the cutting efficiency when the functional portion is removed after the tapered obturating point portion 2 has been correctly placed in the root canal during therapy. The tapered obturating point portion 2 may be adapted to the shape of a root canal instrument used for the preparation of the root canal. Moreover, the tapered obturating point portion 2 may comprise one or more elongated channel portions 22 for draining excess sealant

FIG. 1b is a schematic representation of the crossection of a flat handle portion 33 of a preferred dental device according to the invention.

FIG. 1c shows a dental device according to the invention which does not comprise a stopper means. Similar to the embodiment shown in FIG. 1a, the dental device comprises a tapered obturating point portion 2 integrally connected at the distal end of a functional portion 3. The functional portion 3 comprises a neck portion 32 adjacent to the obturating point portion 2, and a handle portion 33. The neck portion 32 has a reduced diameter as compared to the tapered obturating point portion 2, thereby reducing any undesired visual obstruction. Moreover, the tapered obturating point portion 2 comprises one or more elongated channel portions 22 for draining excess sealant.

FIG. 1d shows the shoulder portion of the tapered obturating point portion 2 integrally connected at the distal end of a functional portion. The tapered obturating point portion 2 has a roughened surface with a number recesses distributed over the surface of the tapered obturating point portion 2. The tapered obturating point portion 2 also comprises an elongated channel portion 22 for draining excess sealant.

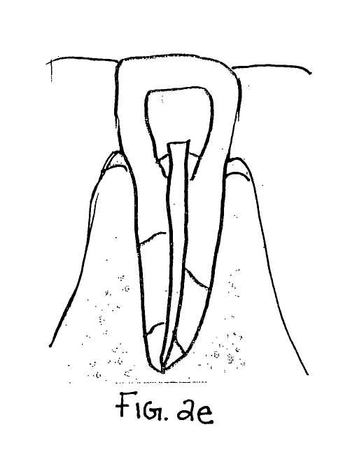

FIG. 2 illustrates steps involved in a root canal therapy using the dental device according to the invention. Accordingly, as shown in FIG. 2a, a root canal is prepared according to standard methods. The tooth shown has a main root canal 100 and lateral canals 101, 102, 103, and 104. Subsequently, the walls of the prepared root canal 100 are coated with a root canal sealant according to conventional techniques in order to provide a coating 110 of the root canal sealant on the wall of the root canal 100 as illustrated in FIG. 2b. The sealant penetrates partially into the lateral canals 101-104. A preferred root canal sealant provides a material when cured which is compatible with the thermoplastic material of the dental device of the present invention. In a next step, a dental device 1 according to the invention is introduced into the root canal 100. The dental device may be held conveniently by the handle portion 33 either directly by hand or indirectly with tweezers. In any case, the mechanical properties of the dental device 1 provide control over the tapered obturating point portion 2 which is pushed forward into the root canal until a desired position of the tapered obturating point portion 2 in the root canal 100 is reached. The depth of the penetration may be easily controlled based on the stopper means 4 which was arranged along the neck portion 32 at a position indicating the distance from the apex of the root canal to the upper limit of the tooth. The distance may easily be mapped to the dental device 1 of the present invention from the dental instrument used for the preparation of the root canal 100. Following the correct placement of the dental device 1 of the invention in the root canal, the device is cut so as to separate the portion of the device permanently remaining in the root canal from the portion including the functional portion of the device. The cuffing may preferably be carried out by a hot instrument as shown in FIG. 2 d.

As a result of the root canal therapy using the dental device according to the invention, the obturating point portion 2 and the sealant form a permanent root canal filling, preferably as a monoblock as shown in FIG. 2e.

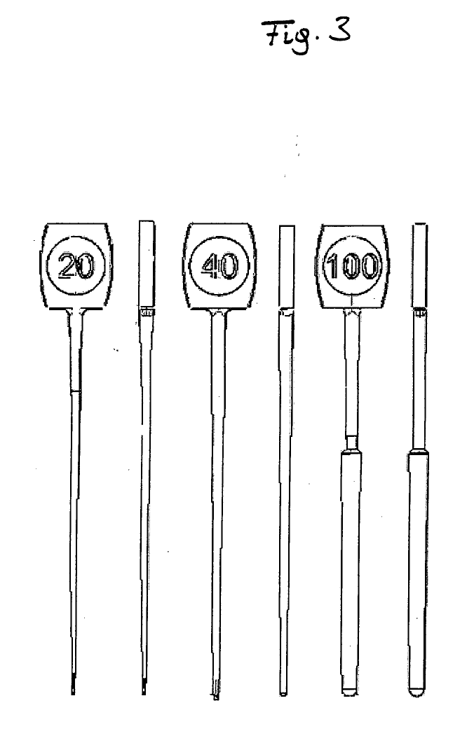

FIG. 3 shows a side-view of a system of dental devices having different obturating point portions. The system shows three different embodiments of the dental device of the invention. Each embodiment is shown in a front view and a corresponding view after a 90° turn around the longitudinal axis of the dental device. The three different embodiments are characterized by different obturating point portions. The nature of the obturating point portion of each embodiment is indicated at the handle portion thereby facilitating identification and selection of a suitable dental device of the invention. The embodiments shown in this figure do not contain an elongated channel portion for draining excess dental sealant.

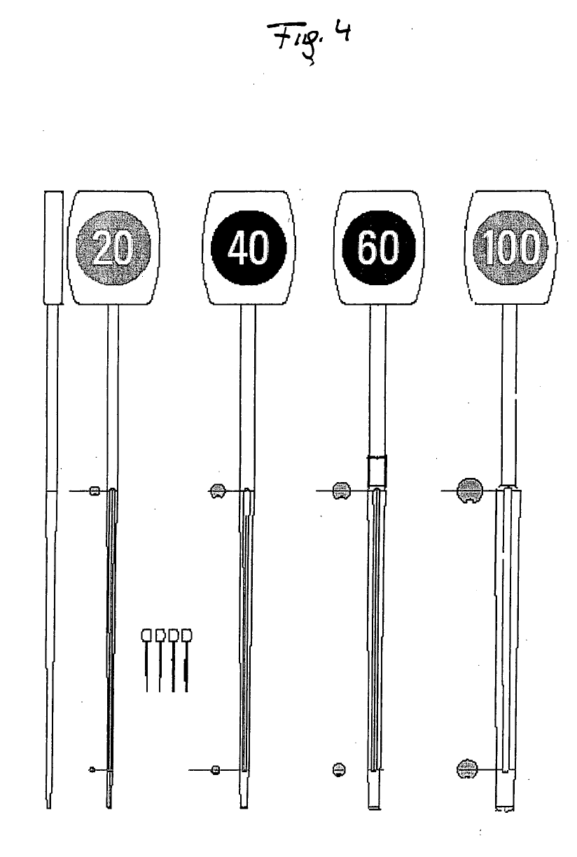

FIG. 4 shows a side-view of a further system of dental devices having different obturating point portions. The system shows four different embodiments of the dental device of the invention. Each embodiment is shown in a front view. Corresponding cross-sections are indicated which show the shape and depth of the elongated channel for draining excess sealant. The three different embodiments are characterized by different obturating point portions. The nature of the obturating point portion of each embodiment is indicated at the handle portion thereby facilitating identification and selection of a suitable dental device of the invention.

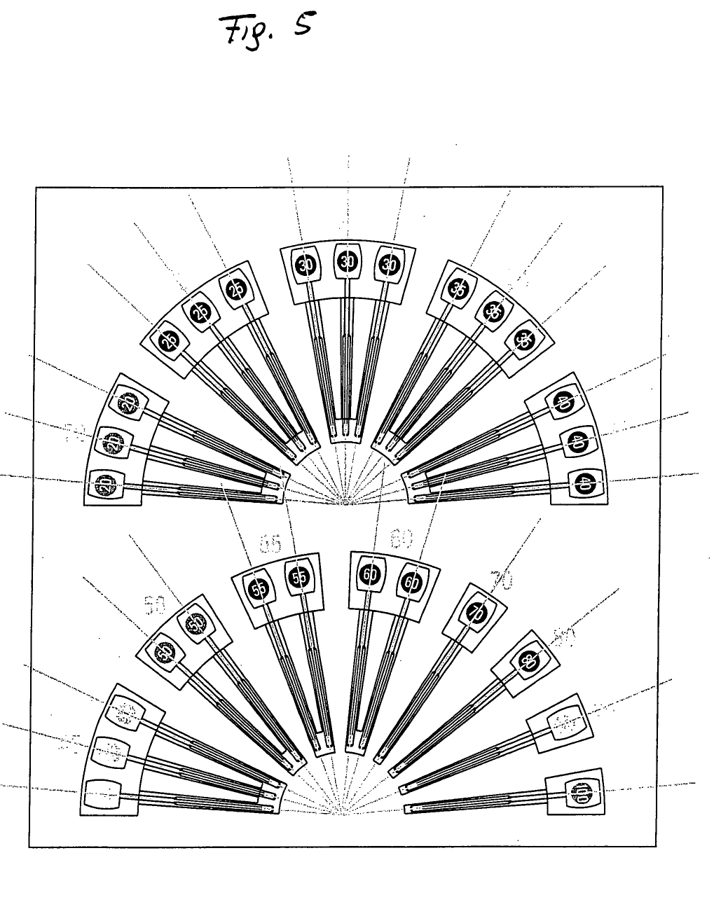

FIG. 5 shows an embodiment of a system of dental devices as shown in FIG. 4 arranged in a suitable tray. The tray comprises recess portions for receiving multiple dental devices according to the invention. Each recess portion is adapted to receive multiple dental devices of the same type. The dental devices of different recess portions are of different type. Each tray portion includes narrow channels for receiving and holding the obturating point portions of a dental device. The handle portion of the dental device is held in a predetermined position for easy identification. The handle portion is presented by the tray so that it may be easily and reliably gripped by the practitioner. The tray presents the dental devices in a predetermined orientation so that the viewing angle of the dental device may be optimized by suitably placing the tray. The depth of the recess portion is adapted so that the handle portion of the dental device does not rotate around the longitudinal axis into a position where the labeling of the handle portion cannot be identified by the practitioner anymore without manipulating the position of the dental device in the tray. The tray may be made of any material such as a plastic material.

The dental device according to the invention is preferably made of a polymeric material. The material may be an uncrosslinked thermoplastic material. The dental material may also be a partially crosslinked material suitable for a thermal shaping process. The dental material preferably has a glass transition temperature in the range of from 0° C. to 150° C., more preferably 20° C. to 100° C., still more preferably 35° C. to 70° C.

In a preferred embodiment, the tapered obturating point portion of the dental device according to the invention has a roughened or otherwise mechanically or chemically modified surface structure for enhancing wetting and adhesion of the endodontic sealant. The tapered obturating point portion may comprise one or more elongated channel portions for draining excess sealant.

In a preferred embodiment, the handle portion has a non-circular cross section. The neck portion may have a circular cross section and a cylindrical shape. Moreover, it is preferred that the neck portion has a diameter which is the same or smaller than the diameter of the maximum diameter of the obturating point portion.

The dental device according to the invention may further comprise a stopper means slidably provided at the neck portion.

The process for preparing a dental device according to the present invention is not specifically limited. Any process conventionally used for shaping products of the required size may be employed such as a moulding process, such as injection moulding, a thermal pressure forming process, and rapid prototyping, a casting process wherein a composition is polymerized in a mould; or by a mechanical process such as milling a device of the invention from a bulk material. A method using a laser or a water jet are also contemplated for the preparation of a dental device according to the present invention.

Preferably, the dental device may be obtained based on a thermoplastic composition. The thermoplastic composition may comprise a thermoplastic polymer and a filler

In a preferred embodiment, the thermoplastic polymer is formed by polymerization of polymerizable diepoxide monomer and amine monomer. The amine monomers may be selected from primary monoamine and/or a disecondary diamine. In a preferred embodiment, the polymerizable composition contains a bisphenol A epoxy resin, a bisphenol F epoxy resin, dibenzylamine, 1-aminoadamantane and/or tricyclodecane diamine.

In case the amine monomer contains a primary monoamine, the amine monomer and the epoxide monomer may be polymerized to form an addition polymer having repeating units (I) according to the following scheme 1:

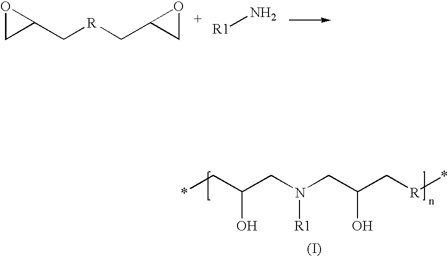

In case the amine monomer contains a disecondary diamine, the amine monomer and the epoxide monomer may be polymerized to form an addition polymer containing repeating units (II) according to the following scheme 2:

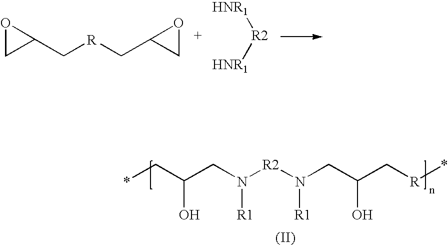

In case the amine monomer contains a mixture of a primary monoamine and disecondary diamine, the amine monomer and the epoxide monomer may be polymerized to form an addition polymer containing repeating units (I) and (II).

In the above schemes 1 and 2, R is a moiety formed from a diepoxide and may be selected from the following groups:

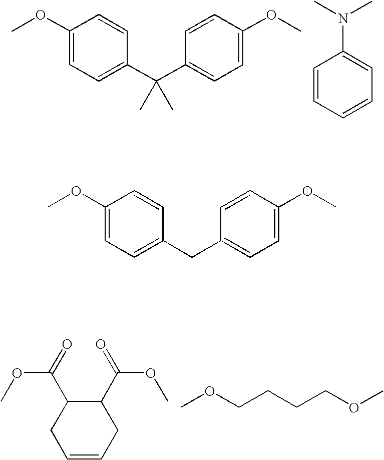

In the above schemes 1 and 2, R1 may be

a substituted C₁ to C₁₈ alkyl group,
a C₁ to C₁₈ polyoxyalkylene group,
a substituted or unsubstituted C₅ to C₁₈ cycloalkyl group,
a substituted or unsubstituted C₅ to C₁₈ aryl or heteroaryl group, whereby the substituted alkyl group, cycloalkyl group, aryl group or heteroaryl group may have 1 to 3 substituents selected from a C₁ to C₆ alkoxy group, a halogen atom such as F, Cl, Br, —COCH₃, NO₂, COOC₂H₅, a hydroxyl group, or a phosphorous containing group such as a phosphonic acid group or a phosphoric acid group.

In the above schemes 1 and 2, R2 may be

a substituted or unsubstituted C₁ to C₁ to C₁₈— alkylene group which may contain 1 to 5 heteroatoms in the chain, which are selected from oxygen and sulfur atoms,

a substituted or unsubstituted C₁ to C₁₈ alkenylene group which may contain 1 to 5 heteroatoms in the chain, which are selected from oxygen and sulfur atoms,

a substituted or unsubstituted C₅ to C₁₈ cycloalkyl group which may contain 1 to 5 heteroatoms in the ring chain, which are selected from oxygen and sulfur atoms,
a substituted or unsubstituted C₅ to C₁₈ arylene or heteroarylene group, whereby the substituted alkylene group, alkenylene group, cycloalkylene group, arylene group or heteroarylene group may have 1 to 3 substituents selected from a C₁ to C₆ alkoxy group, a halogen atom such as F, Cl, Br, —COCH₃, NO₂, COOC₂H₅, a hydroxyl group, or a phosphorous containing group such as a phosphonic acid group or a phosphoric acid group. Preferably, the epoxide monomer is a diepoxide selected from the group of diglycidylethers such as diglycidyl ether of bisphenol-A, diglycidyl ether of bis-phenol-F, butandiol diglycidyl ether, N,N-diglycidylaniline or Δ³-tetrahydrophthalic acid diglycidyl ester. As a specific example, bis-2,2-[4-(2,3-epoxypropoxy)-phenyl]-propane may be mentioned.

Preferably, the disecondary diamine is selected from N,N′-dibenzyl ethylene diamine, N,N′-dibenzyl-3,6-dioxa-octandiamine-1,8,N,N′-dibenzyl-5-oxanonane diamine-1,9, N,N′-dibenzyl-(2,2,4)/(2,4,4)-trimethylhexamethylene diamine, N,N′-dicyclohexyl ethylene diamine, and N,N′-dimethyl-p-xylylene diamine. N,N′-dibenzyl-5-oxanonane diamin-1,9 is particularly preferred.

Preferably, the primary monoamine is selected benzylamine, 1-amino adamantane, α-phenethylamine and ethanol amine. 1-Amino adamantane is preferred.

It is possible to use a partially crosslinked thermoplastic material. Cross linking may be carried out by using a small amount of polyfunctional amine or the like in the polycondensation reaction. Moreover, it is possible to use a small amount of monomers having radically polymerizable groups when preparing the thermoplastic material. The radically polymerizable groups may subsequently be polymerized for cross linking. Partial Cross linking may be used in order to adapt the mechanical properties of the thermoplastic material.

The thermoplastic material may contain the filler in an amount of from 40 to 90 weight-% based on the thermoplastic material. The filler provides a desirable radioopacity and mechanical properties. Preferably, the material has a radio-opacity of at least 3 mm/mm aluminum. The filler may be an inorganic filler such as La₂O₃, ZrO₂, BiPO₄, CaWO₄, BaWO₄, SrF₂, Bi₂O₃. The filler may also be an organic fillers, such as a polymer granulate, splinter polymers. The filler may further be a combination of organic and/or inorganic fillers. The fillers provide preferably a radio-opacity of at least 3 mm/mm Al, more preferably at least 5 to 7 mm/mm Al, most preferably at least 7 mm/mm Al to the material.

In a preferred embodiment, the material is soluble in polar organic solvents such as chloroform, tetrahydrofurane or dimethyl formamide. The material may further contain additives such as a stabilizer and a plasticizer.

According to the invention a dental device for use in the obturation of a root canal may be fabricated out of a material which is much stronger than a conventional gutta percha material and flexible and offers mechanical properties similar to the instruments used to prepare the root canal. Accordingly, the point can easily pass a curved area and can be placed in a controlled manner in the final position, i.e. up to the same length as the root canal was prepared.

Typically, the formation of the dental device may be carried out by compression molding wherein a heated mold is squeezed around a pre-formed blank. More preferably, the formation of the dental device may be carried out by injection molding wherein a power or pellet is liquified, injected into a mold, cooled under pressure, and ejected. Accordingly, the thermoplastic material containing the addition polymer moves from a hopper means into an injection unit comprising a screw means and heated wall means. Due to the movement of the turning screw means, the material moves along the hot wall means of the injection unit towards the injection nozzle. Due to the hot cylinder wall and the shear forces generated by the screw means, the material is plastified. The injection nozzle is arranged so as to inject the plastified material into a die. According to the present invention, the injection unit is operated so that the material is heated for injection molding at the injection nozzle to a temperature which is 110° to 150° C., preferably 120° to 140° C. above the glass transition temperature of the material. Moreover, the injection unit is operated so that the injection pressure is in the range of from 400 to 600 bar. After injection of the material into the die, the die is kept under pressure so as to reduce undesired shrinkage of the solidifying material in the mold. The dental device obtained accordingly is removed from the die after solidification.

The invention will now be illustrated in further detail based on the following examples.

### Example 1

608,434 g (1.787 mol) of bis-2,2-[4-(2,3-epoxypropoxy)-phenyl]-propane, 216,045 g (0.634 mol) N,N′-dibenzyl-5-oxanonane diamin-1,9 and 175,521 g (1.153 mol) amino adamantane, are reacted at ambient temperature in an aluminum vessel for 72 hours at 70° C. The addition polymer thus obtained has a glass transition temperature of Tg=58.0° C. The particle size of the bulk polymer is mechanically reduced and the particles are further processed in an injection moulding method.

The polymer is extruded into a mould at a nozzle temperature of 180° C. at a pressure of 500 bar.

### Example 2

550,000 g (1,616 mol) bis-2,2-[4-(2,3-epoxypropoxy)-phenyl]-propane, 275,081 g (0,808 mol) N,N′-dibenzyl-5-oxanonane diamine-1,9,122,991 g (0,808 mol) amino adamantane, 2259,125 g calcium tungstenate (particle size 0.5 μm) and 20,350 g Aerosil A200 are homogeneously mixed in a mixer and the mixture is polymerized at 70° C. for 24 hours. After reduction of the particle size of the bulk polymer, extrusion into a mould is carried out at a nozzle temperature of 180° C. and a moulding pressure of 500 bar. The points thus obtained have a radioopacity of 10.4 mm/mm Al and are useful as dental obturating points.

1. Kit-of-parts containing
(i) a dental device for use in the obturation of a root canal which comprises a tapered obturating point portion integrally connected at the distal end of a functional portion, whereby the functional portion comprises
(a) a neck portion adjacent to the obturating point portion, and
(b) a handle portion, and
(ii) a dental sealant composition,
wherein the dental device is made of a material obtainable by curing a composition containing one or more curable components contained in the dental sealant.

2. The kit-of-parts according to claim 1, wherein the dental device is made of a thermoplastic material.

3. The kit-of-parts according to claim 1, wherein the dental device is made of a partially crosslinked material suitable for a thermal shaping process.

4. The kit-of-parts according to any one of claims 2 or 3, wherein the material of the dental device has a glass transition temperature in the range of from 0° C. to 150° C.

5. The kit-of-parts according to any one of the preceding claims, wherein the tapered obturating point portion of the dental device has a roughened or mechanically or chemically modified surface structure.

6. The kit-of-parts according to any one of the preceding claims, wherein the tapered obturating point portion of the dental device comprises an elongated channel portion for draining excess sealant.

7. The kit-of-parts according to any one of the preceding claims, wherein the handle portion of the dental device has a non-circular cross section.

8. The kit-of-parts according to any one of the preceding claims, wherein the neck portion of the dental device has a diameter which is the same or smaller than the diameter of the maximum diameter of the obturating point portion.

9. The kit-of-parts according to any one of the preceding claims, wherein a stopper means is slidably provided at the neck portion of the dental device.

10. The kit-of-parts according to any one of claims 1 to 9, wherein the dental device is obtained or obtainable by a moulding process.

11. The kit-of-parts according to any one of claims 1 to 10, wherein the dental device is obtained or obtainable by a process selected from injection moulding, thermal pressure forming process, and rapid prototyping.

12. The kit-of-parts according to any one of the preceding claims, wherein the dental device is made of a material obtainable by a chain growth polymerization reaction.

13. The kit-of-parts according to any one of claims 1 to 11, wherein the dental device is made of a material obtainable by a step-growth polymerization reaction.

14. The kit-of-parts according to claim 13, wherein the dental device is made of a material containing an epoxide-amine polymer.

15. Dental device as defined in any one of claims 1 to 14.

16. Use of a dental device according to claim 15 in a kit-of-parts according to any one of claims 1 to 14.
